(19) United States
(12) Patent Application Publication
(10) Pub. No.: US 2012/0296932 A1
(43) Pub. Date: Nov. 22, 2012

(54) METHOD AND APPARATUS FOR IDENTIFIER RETRIEVAL

(75) Inventors: Sheng Hua Bao, Beijing (CN); HongLei Guo, Beijing (CN); Zhong Su, Beijing (CN); Jian Yao, Beijing (CN); Li Zhang, Beijing (CN); Shuo Zhang, Beijing (CN); Hui Jia Zhu, Beijing (CN)

(73) Assignee: International Business Machines Corporation, Armonk, NY (US)

(21) Appl. No.: 13/471,515

(22) Filed: May 15, 2012

(30) Foreign Application Priority Data
May 18, 2011 (CN) 201110145948.2

(51) Int. Cl. G06F 17/30

(52) U.S. Cl. 707/769; 707/E17.014

(57) ABSTRACT

A method for identifier retrieval. The method can include the steps of: extracting candidate identifiers from a data source according to a source identifier; obtaining a profile of the source identifier and profiles of the candidate identifiers from the data source; and selecting a target identifier associated with the source identifier from the candidate identifiers according to the profile of the source identifier and the profiles of the candidate identifiers. The method may efficiently, accurately and rapidly find a target identifier associated with a source identifier.

### CROSS REFERENCE TO RELATED APPLICATION

This application claims priority under 35 U.S.C. 119 from Chinese Application 201110145948.2, filed May 18, 2011, the entire contents of which are incorporated herein by reference.

### BACKGROUND OF THE INVENTION

1. Field of the Invention

Embodiments of the present invention relate to the field of information retrieval, and more specifically, to a method and apparatus for identifier retrieval.

2. Description of the Related Art

In the current era of competition, it is important to obtain effective competitive information in various aspects, such as business, and increasingly more companies consider and synthesize competitive information when composing a business strategy. Traditionally, people have manually collected the desired competitive information via marketing surveys.

With the increasing development of society and information technology, the Internet provides more and more information to people, and at the same time, people transfer more and more information to the Internet. Much information is organized in text, such as news, introductory articles, reviews, etc. A considerable amount of content of the textual information is associated with categories of named entities, such as products, persons, organizations, etc. For example, many introductory articles and commentary articles on Internet hardware or software websites contain a large quantity of product information.

However, it is quite time-consuming and also impractical to manually obtain competitive information of companies from the Internet that contains mass data.

For example, when a user wants to know which companies are competitors of company A or which products are in a competitive relation with a given product of company A, he/she may use a source identifier to represent a product to be queried, and may retrieve a target identifier representing a competitive product by means of some reviews or introductory information on the Internet. At this point, if mass data on the Internet are browsed manually, it is impossible to accomplish such retrieval efficiently, accurately and rapidly.

### BRIEF SUMMARY OF THE INVENTION

In order to overcome these deficiencies, the present invention provides a computer-implemented method for identifier retrieval, including: extracting candidate identifiers from a data source according to a source identifier; obtaining a profile of the source identifier and profiles of the candidate identifiers from the data source; and selecting a target identifier associated with the source identifier from the candidate identifiers according to the profile of the source identifier and the profiles of the candidate identifiers.

According to another embodiment, the present invention provides an apparatus for identifier retrieval, including: extracting means configured to extract candidate identifiers from a data source according to a source identifier; obtaining means configured to obtain a profile of the source identifier and profiles of the candidate identifiers from the data source; and selecting means configured to select a target identifier associated with the source identifier from the candidate identifiers according to the profile of the source identifier and the profiles of the candidate identifiers.

### BRIEF DESCRIPTION OF THE SEVERAL VIEWS OF THE DRAWINGS

As the present invention is apprehended more thoroughly, other objects and effects of the present invention will become more apparent and easier to understand by means of the following description with reference to the accompanying drawings, wherein:

FIG. 1 is a flowchart of a method for identifier retrieval according to one embodiment of the present invention;

FIG. 2A is a flowchart of a method for identifier retrieval according to another embodiment of the present invention;

FIG. 2B is a continuation of the flowchart in FIG. 2A;

FIG. 3A is an example that can be used as a profile, according to an embodiment of the present invention

FIG. 3B is an example that cannot be used as a profile according to an embodiment of the present invention;

FIG. 4 is a block diagram of an apparatus for identifier retrieval according to one embodiment of the present invention; and

FIG. 5 is structural block diagram of a computer system in which embodiments of the present invention can be implemented.

Like numerals represent the same, similar or corresponding features or functions throughout the figures.

### DETAILED DESCRIPTION OF THE PREFERRED EMBODIMENTS

More detailed description will be presented below to embodiments of the present invention by referring to the figures. It is to be understood that the figures and embodiments of the present invention are merely for illustration, rather than to limit the scope of protection of the present invention.

The flowcharts and block diagrams in the figures illustrate the system, methods, as well as architecture, functions and operations executable by a computer program product according to various embodiments of the present invention. In this regard, each block in the flowcharts or block diagrams may represent a module, a program segment, or a part of code, which contains one or more executable instructions for performing specified logic functions. It should be noted that in some alternative implementations, functions indicated in blocks may occur in an order differing from the order as shown in the figures. For example, two blocks shown consecutively can be performed in parallel substantially or in an inverse order sometimes, which depends on the functions involved. It should be further noted that each block and a combination of blocks in the block diagrams or flowcharts can be implemented by a dedicated, hardware-based system for performing specified functions or operations or by a combination of dedicated hardware and computer instructions.

Technical terms used in embodiments of the present invention are first explained for the purpose of clarity.

### 1. Data Source

A data source can be user generated content (UGC), such as commentary information, news, a microblog, a blog, a bulletin board system (BBS) and other content on the Web with respect to a certain product or company, or any other content that can be browsed or viewed by users via a communication network.

In addition, a data source can be an ontology. An ontology can be used to capture knowledge in a related domain, provide common understanding of knowledge in the domain, determine vocabulary or concepts commonly recognized in the domain, and provide explicit definition of mutual relationships among these concepts from formalized patterns at different levels. Semantically speaking, relations between concepts can include: “part-of,” which represents a relation between part and entirety of concepts; “kind-of,” which represents an inheritance relation between concepts; “instance-of,” which represents a relation between an instance of a concept and the concept; and “attribute-of,” which represents that a certain concept is an attribute of another concept. In practical applications, relations between concepts are not limited to the above-enumerated four relations; rather, corresponding relations can be defined according to specific conditions of a domain. Ontologies that are currently in common use include, for example, Wordnet, Framenet, GUM, SENSUS, Mikrokmos, etc. Among them, Wordnet, an English lexicon based on psychological language rules, organizes information in the unit of synsets (sets of interchangeable synonyms in specific context). Framenet, an English lexicon, provides relatively strong semantic analysis capabilities by using a description frame referred to as Frame Semantics and currently is developed as FramenetII. GUM, natural language-oriented processing, supports multilingual processing and includes basic concepts and conceptual organization forms independent of various specific languages. SENSUS, also natural language-oriented processing, provides conceptual mechanisms for machine translation and includes more than 70,000 concepts. Mikrokmos, also natural language-oriented processing, supports multilingual processing and represents knowledge by using an intermediate language TMR among languages.

In addition, a data source can be a pre-established product knowledge base, including products' brand names, product models, companies owning them, product categories, and other product attribute information, etc.

### 2. Named Entity

A named entity (hereinafter referred to as an “entity” for short) is an important language unit carrying information in text and plays a significant role in various domains such as information abstraction, machine translation, automatic abstracting, etc. Named entity recognition (NER) mainly refers to recognizing named denotative items of entity concepts in data sources. Categories of named entities mainly include “persons,” “locations,” “organizations,” “time,” “quantity,” “products,” etc.

### 3. Identifier

An identifier may represent an entity by using, for example, the entity's full name, abbreviated name, English abbreviation and the like. An identifier can be inputted by a user directly, obtained from a data source according to an inputted object, or determined according to named entity recognition.

### 4. Object

An object can be an entity corresponding to an identifier. For example, when an identifier represents a product, an object may represent a company to which the product belongs, which can be the company's full name, abbreviated name, English abbreviation and the like.

An identifier may correspond to an object. In the present invention, one identifier may correspond to one or more objects, while one object may also correspond to one or more identifiers. Specifically, one product may belong to one or more companies or be a cooperative result of two companies, i.e., the product may belong to two companies. Meanwhile, one company may have one or more products, thereby having one or more products corresponding thereto.

In one embodiment of the present invention, a computer-implemented method for identifier retrieval is presented. In this embodiment, candidate identifiers are extracted from a data source according to a source identifier and a profile of the source identifier, and profiles of the candidate identifiers are obtained from the data source, and finally, an identifier associated with the source identifier is selected from the candidate identifiers as a target identifier according to the obtained profile of the source identifier and profiles of the candidate identifiers.

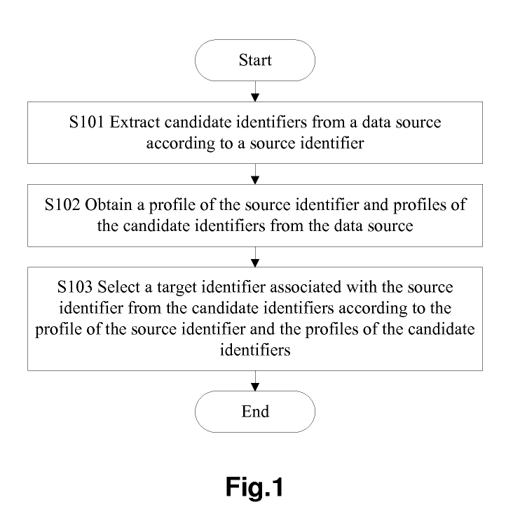

FIG. 1 illustrates a flowchart of a method for identifier retrieval according to one embodiment of the present invention.

In step S101, candidate identifiers are extracted from a data source according to a source identifier.

In this step, named entity recognition can be first performed on the data source, and then identifiers that belong to the same entity category as the source identifier can be extracted as candidate identifiers from the recognized named entities.

In step S102, a profile of the source identifier and profiles of the candidate identifiers are obtained from the data source.

It is possible to search the data source for information related to the source identifier so as to be used as a profile of the source identifier. For example, it is possible to search the profile of the source identifier for descriptive information on the source identifier, and to update the profile of the source identifier with the descriptive information on the source identifier.

Also it is possible to search the data source for information related to the candidate identifiers so as to be used as profiles of the candidate identifiers. For example, it is possible to search the profiles of the candidate identifiers for descriptive information on the candidate identifiers, and to update the profiles of the candidate identifiers with the descriptive information on the candidate identifiers.

In step S103, a target identifier associated with the source identifier is selected from the candidate identifiers according to the profile of the source identifier and the profiles of the candidate identifiers.

An identifier associated with the source identifier can be selected as a target identifier from the candidate identifiers by calculating a similarity between the source identifier and each of the candidate identifiers and then comparing the similarity with a predetermined threshold. The predetermined threshold can be obtained according to experience, or preset or obtained by those skilled in the art in any other proper manner.

The similarity between the source identifier and a candidate identifier can be calculated by various approaches. For example, keyword(s) (hereinafter referred to as “source keyword(s)”) can be extracted from the profile of the source identifier, then keywords (hereinafter referred to as “candidate keyword(s)”) can be extracted from the profile of a candidate identifier, and finally, the similarity is calculated according to the source keyword(s) and the candidate keyword(s). For another example, the profile of the source identifier can be directly compared with the profile of the candidate identifier by using, for example, a comparison approach for two sentences or a comparison approach for two paragraphs to calculate the similarity between the source identifier and the candidate identifier according to the profile of the source identifier and the profile of the candidate identifier.

In another embodiment of the present invention, a temporal order between the source identifier and the candidate identifiers can be determined based on the profile of the source identifier and the profiles of the candidate identifiers; a target identifier associated with the source identifier can be selected from candidate identifiers, when the temporal order meets a predetermined requirement.

Then, the flow of FIG. 1 ends.

In one embodiment of the present invention, before step S101, a source object input by a user can be received, and an identifier corresponding to the source object is looked up in the data source and subsequently used as the source identifier in steps S101 to S103.

In one embodiment of the present invention, after step S103, a source object corresponding to the source identifier and a target object corresponding to the target identifier can be determined, and the determined source object is associated with the determined target object.

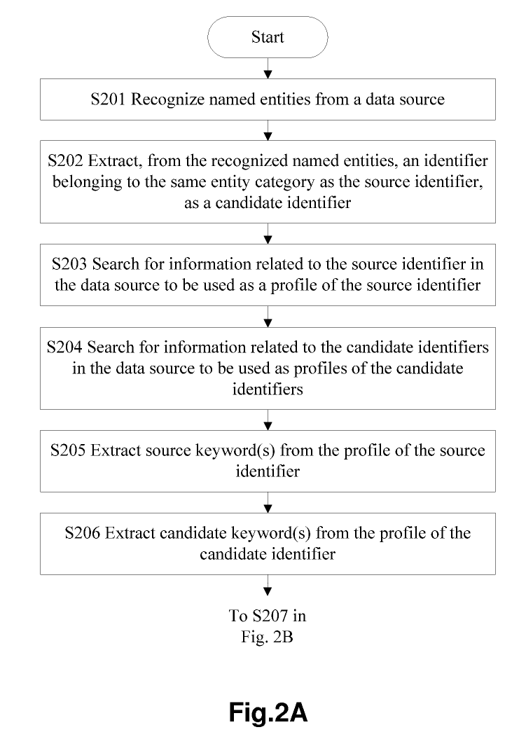

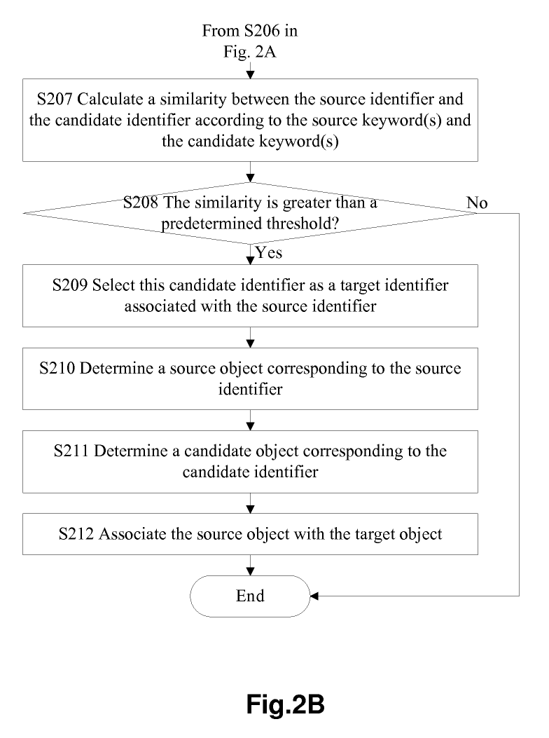

FIGS. 2A and 2B illustrate a flowchart of a method for identifier retrieval according to another embodiment of the present invention.

In step S201, named entities are recognized from a data source.

Typically named entity recognition refers to recognizing named denotative items of entity concepts in a data source. As described above, categories of named entities mainly include “persons,” “locations,” “organizations,” “time,” “quantity,” “products”, etc. Thus, entities of categories such as persons, locations, organizations, time, quantity, products, etc. can be obtained after performing named entity recognition to the data source.

In step S202, an identifier belonging to the same entity category as the source identifier is extracted as a candidate identifier from the recognized named entities.

In this step, it is possible to first judge an entity category to which the source identifier belongs, and then according to the entity category, determine a candidate identifier from the entities recognized in step S201.

In one embodiment of the present invention, suppose the source identifier is “DB2,” which represents a product of International Business Machine (IBM®) Corporation. In step S202, first it can be judged that the source identifier “DB2” represents an entity in the category of “products”; then, an entity belonging to the product category can be looked up in the entities recognized in step S201 and used as a candidate identifier. In this embodiment, suppose the candidate identifiers include three entities in the category of “products,” namely “SQL Server®” “Windows®,” and “iPhone®.”

It should be noted that in the present invention, the source identifier is not limited to only include entities in the product category, but can be applicable to entities in other categories such as persons, locations, organizations, time, quantity, products, etc.

For example, in another embodiment of the present invention, suppose the source identifier is “Jobs,” at which point the source identifier represents the leader of Apple Inc. In step S202, first it can be judged that the source identifier “Jobs” is an entity in the “persons” category; then, an entity belonging to the “persons” category can be looked up in the entities recognized in step S201 and used as a candidate identifier. In this embodiment, suppose the candidate identifiers include three entities in the “persons” category, namely “Zhang San,” “Bill Gates,” and “Obama.”

In step S203, information related to the source identifier is searched for in the data source to be used as a profile of the source identifier.

In embodiments of the present invention, information related to the source identifier “DB2” can be sentences, fragments, paragraphs, articles, or other types of content, which contain relations of comparison, enumeration, parallel, competition and so on. For example, it can be determined from the expression “Such as DB2, A, B and C” that DB2 is in a parallel or enumeration relation with A, B and C, so content containing the expression “Such as DB2, A, B and C” can be determined as information related to the source identifier “DB2” and further used as a profile of the source identifier “DB2.” Besides, it can be determined from both of the expressions “DB2 vs. A” and “Which one is better, DB2 or A?” that DB2 is in a comparison or competition relation with A, so content containing “DB2 vs. A” or “Which one is better, DB2 or A?” may also be determined as information related to the source identifier “DB2” and further used as its profile.

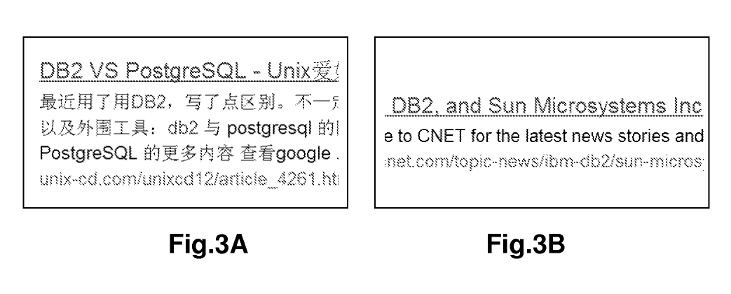

FIG. 3A illustrates an example that can be used as a profile. In this example, “DB2 VS PostgreSQL” is contained, which represents that DB2 is in a comparison or competition relation with PostgreSQL, so this fragment can be used as a profile of the identifier “DB2.” On the other hand, if “PostgreSQL” is also regarded as an identifier, then the fragment illustrated in FIG. 3A can be used as a profile of the identifier “PostgreSQL.”

FIG. 3B illustrates an example that cannot be used as a profile. In this example, “DB2” and “Sun Microsystems®” are not in a parallel or enumeration relation; rather, they have little relevance. Hence, this fragment cannot be used as a profile of “DB2” or “Sun Microsystems®.”

In one embodiment of the present invention, the source identifier's profile obtained in step S203 can be optimized such that the optimized profile is more helpful to accurately determine a target identifier associated with the source identifier. For example, it is possible to look up descriptive information on the source identifier in the profile of the source identifier and update the profile of the source identifier with the descriptive information, so that the profile of the source identifier is optimized.

There are a number of implementing approaches to look up descriptive information in the profile of the source identifier. In one example, a focused named entity recognition or other filtering approach can be first performed on the profile to remove from the profile content that has little relevance with the source identifier, whereby a subset S1 of the profile is obtained; then, the subset S1 is used as descriptive information to replace the current profile of the source identifier. In another example, a focused named entity recognition or other filtering approach can be first performed on the profile to remove from the profile content that has little relevance with the source identifier, whereby a subset S1 is obtained; next, a subset S2, i.e., introductory or descriptive content regarding the source identifier, can be detected from the subset S1 by using a classification algorithm such as Naive Bayes, support vector product, KNN, etc.; finally, the subset S2 is used as descriptive information to replace the current profile of the source identifier.

In step S204, information related to the candidate identifiers is searched for in the data source to be used as profiles of the candidate identifiers.

Like the source identifier's profile in step S203, information related to a candidate identifier can be sentences, fragments, paragraphs, articles, or other types of content, which contain relations of comparison, enumeration, parallel, competition and so on.

In the foregoing embodiment, supposing the candidate identifiers include three entities in the product category, namely “SQLServer®,” “Windows®,” and “iPhone®,” then in step S204, respective information associated with the three candidate identifiers is searched for in the data source and used as profiles of the three candidate identifiers respectively.

In one embodiment of the present invention, the candidate identifier's profile obtained in step S204 can be optimized such that the optimized profile is more helpful to accurately determine a target identifier associated with the source identifier. For example, it is possible to look up descriptive information on the candidate identifier in the profile of the candidate identifier and update the profile of the candidate identifier with the descriptive information, so that the profile of the candidate identifier is optimized.

There are a number of implementing approaches to look up descriptive information in the profile of the candidate identifier. In one example, first, a focused named entity recognition or other filtering approach can be performed on the profile to remove from the profile content that has little relevance with the candidate identifier, whereby a subset S1 of the profile is obtained; then, the subset S1 is used as descriptive information to replace the current profile of the candidate identifier. In another example, first, a focused named entity recognition or other filtering approach can be performed on the profile to remove from the profile content that has little relevance with the candidate identifier, whereby a subset S1 is obtained; next, a subset S2, i.e., introductory or descriptive content regarding the candidate identifier, can be detected from the subset S1 by using a classification algorithm such as Naive Bayes, support vector product, KNN, etc.; finally, the subset S2 is used as descriptive information to replace the current profile of the candidate identifier.

In step S205, source keyword(s) is/are extracted from the profile of the source identifier.

Various keyword extracting approaches that are known in the art can be used to perform step S205. Known keyword extracting algorithms include frequency or rule-based keyword extraction, such as a statistics-based approach and a rule-based approach. Among them, the statistics-based approach can be easily implemented without a complex training process, for example, an approach based on word co-occurrence; and the rule-based approach trains discrete eigenvalues of phrases by using, for example, Naive Bayes technique to obtain weights of a model. Known keyword extracting algorithms further include keyword extraction based on semantic part-of-speech features, which can extract keywords with a relatively high accuracy rate, for example, an approach based on natural language understanding, referring to “Zhang Yingying et al., Chinese Keyword Extracting Algorithm Based on Synonyms Chain, Computer Engineering, 2010, 36(19): 93-95,” “Zhang Hong, Keyword Extracting Algorithm Based on Automatic Text Classification, 2009, 35(12): 145-147,” “Medelyan O, Witten I H. Thesaurus Based Automatic Keyphrase Indexing[C]//Proc. of the Joint Conference on Digital Libraries. Chapel Hill, N.C., USA: [s. n.], 2006: 296-297,” or “Ercan G, Ciekli I. Using Lexical Chains for Keyword Extraction[J]. Information Processing and Management, 2007, 43(6): 1705-1714,” etc.

In one embodiment of the present invention, when the source identifier represents an entity in the product category, the source keyword can be, for example, one or more keywords in the profile of the source identifier that are used for describing information such as product model, series, technical parameter, occurrence frequency, etc.

In another embodiment of the present invention, when the source identifier represents an entity in the “persons” category, the source keyword can be, for example, one or more keywords in the profile of the source identifier that are used for describing information such as position, diploma, profession, service period, occurrence frequency, etc.

In step S206, candidate keyword(s) is/are extracted from the profile of the candidate identifier.

This step is implemented in a similar way to step S205. The difference is that the candidate keyword is one or more keywords in the profile of the candidate identifier, i.e., coming from a different source other than the source keyword.

In step S207, the similarity between the source identifier and the candidate identifier is calculated according to the source keyword(s) and the candidate keyword(s).

The similarity between the source identifier and the candidate identifier can be obtained by various similarity calculating approaches. In one embodiment of the present invention, a vector with the source keyword can be obtained according to the source keywords obtained in step S205, which is referred to as a source vector; likewise, a vector with the candidate keyword can be obtained according to the candidate keywords obtained in step S206, which is referred to as a candidate vector. According to the obtained source vector and the candidate vector, the similarity between them can be calculated by calculating the cosine angle therebetween.

Further, the similarity between the source identifier and the candidate identifier can be calculated by using a similarity calculating method such as the Davis coefficient, Chi-square, log likelihood ratio, F1 measure, and the like.

In step S208, it is judged whether the similarity calculated in step S207 is greater than a predetermined threshold or not. If yes, the flow proceeds to step S209; if not, the flow ends.

The predetermined threshold used for comparison with the similarity as calculated in step S207 can be obtained in various manners. For example, the predetermined threshold can be obtained according to experience, or can be preset or obtained by those skilled in the art in any other proper manner.

In the embodiment described according to step S202, suppose the source identifier is product “DB2” of IBM® Corporation, and the candidate identifier recognized in step S202 are “SQLServer®,” “Windows®,” and “iPhone®.” Suppose it is calculated in step S207 that the similarity between the source identifier “DB2” and the first candidate identifier “Windows®” is 0.2, the similarity between the source identifier “DB2” and the second candidate identifier “iPhone®” is 0.1, and the similarity between the source identifier “DB2” and the third candidate identifier “SQLServer®” is 0.8. In addition, suppose a predetermined threshold is 0.6. Then, it can be judged in step S208 that the similarity between the third candidate identifier “SQLServer®” and the source identifier “DB2” is greater than the predetermined threshold.

In step S209, this candidate identifier is selected as a target identifier associated with the source identifier.

At this point, it can be determined that the target identifier associated with the source identifier is the third candidate identifier “SQLServer®.”

In the present invention, two identifiers being “associated with” each other may represent that these two identifiers have a competition relation, a comparison relation, or any other proper predefined relation. Through the foregoing steps, it is possible to realize the procedure of looking up a target identifier from a source identifier. In practical application, the product “SQLServer®” in a competition relation with the product DB2 can be found through this procedure of lookup.

In another embodiment of the present invention, suppose the source identifier is “Jobs,” an entity in the “persons” category; and suppose the candidate identifiers include three entities in the “persons” category, namely “Zhang San,” “Bill Gates,” and “Obama.” After the processing in steps S203 to S209, it can be determined that “Bill Gates” is the target identifier according to the fact that the similarity between “Bill Gates” and “Jobs” is greater than the predetermined threshold. In this way, the retrieval of the associated target identifier from the source identifier is realized.

In step S210, a source object corresponding to the source identifier is determined.

In one embodiment of the present invention, the source identifier is “DB2.” Since it is a product of International Business Machine (IBM®) Corporation, it can be determined that a source object corresponding to the source identifier “DB2” is “International Business Machine Corporation.” It should be noted that the source object can be an abbreviated name, an abbreviation, a general name of International Business Machine Corporation, or any name that is capable of identifying the company and frequently used by users, such as “IBM,” etc.

In step S211, a target object corresponding to the target identifier is determined.

Like step S210, this step may determine a company to which a product represented by the target identifier belongs, according to the product. For example, for the target identifier “SQLServer®,” it can be determined that a target object corresponding to it is “Microsoft Corporation.” It should be noted that the target object can be “Microsoft Corporation,” or an abbreviated name, an abbreviation, a general name of Microsoft Corporation, or any name that is capable of identifying the company and frequently used by users, such as “Microsoft®,” or “MS.”

In step S212, the source object is associated with the target object.

At this point, it can be determined that the target object associated with the source object (e.g., “IBM®”) is “Microsoft®.”

In the present invention, two identifiers being “associated with” each other may represent that these two identifiers have a competition relation, a comparison relation, or any other proper predefined relation. Through the foregoing steps, it is possible to realize the procedure of looking up a target object from a source object. In practical applications, by means of finding out that the product SQLServer® is in a competition relation with the product DB2, it can be determined that Microsoft® is in a competition relation with IBM®.

In an example of the present invention, when associating the source object with the target object, an exemplary result can be outputted as below:
“IBM vs Microsoft (DB2 vs SQLServer)
“IBM vs Oracle (DB2 vs Oracle) . . . ”

The foregoing result indicates that IBM® and Microsoft® have an association (e.g., competition) relation due to their respective products DB2 and SQLServer®; also IBM® and Oracle® have an association (e.g., competition) relation due to their respective products DB2 and Oracle®.

Then, the flow of FIG. 2 ends.

It should be noted that steps S210 to S212 are not indispensable but optional. The target identifier associated with the source identifier is already capable of being determined in step S209. Steps S210 to S212 expand this procedure, thereby realizing determination of the target object associated with the source object according to the association between the source identifier and the target identifier.

In one embodiment of the present invention, before step S201, a source object input by a user can be received (for example, a user inputs “IBM”), subsequently an identifier (e.g., “DB2”) corresponding to the source object can be looked up in the data source, and the identifier can be used as the source identifier used in steps S201 to S212. It should be noted that the source identifier is not limited to only coming from a source object input by a user; it can be directly inputted by the user or obtained in any other proper manner those skilled in the art may contemplate.

In another embodiment of the present invention, the procedure of selecting a target identifier associated with the source identifier from the candidate identifiers according to the profile of the source identifier and the profiles of the candidate identifiers can be further implemented in the following manner: determining a temporal order between the source identifier and the candidate identifiers based on the profile of the source identifier and the profiles of the candidate identifiers; and selecting a target identifier associated with the source identifier from candidate identifiers when the temporal order meets a predetermined requirement.

In one specific implementation, temporal information related to the source identifier can be recognized in the profile of the source identifier, temporal information related to the candidate identifiers can be recognized in the profile of the candidate identifier, and a temporal order between the source identifier and each of the candidate identifiers is determined by comparing the temporal information; afterwards, candidate identifiers that do not meet a predetermined requirement can be removed or filtered. For example, it can be determined that the source identifier “DB2” is released before or after the candidate identifier “SQLServer®”. When a predetermined requirement is that the source identifier should be released before the candidate identifier, a candidate identifier released before the source identifier “DB2” is removed. Then, a candidate identifier released after the source identifier “DB2” can be determined as a target identifier associated with the source identifier.

In another specific implementation, temporal information related to the source identifier and temporal information related to the candidate identifiers can be recognized from the profile of the source identifier and the profile of the candidate identifier, respectively. Then, a temporal order between the source identifier and each of the candidate identifiers can be determined by comparing the temporal information; next, a candidate identifier that does not meet a determined requirement can be removed or filtered according to the requirement; subsequently, a target identifier can be selected from the candidate identifiers according to steps S205 to S209.

In another embodiment of the present invention, when there are a relatively large number of source identifiers and/or target identifiers, association relations between source identifiers and target identifiers can be built in the form of a graph, which are referred to as an “identifier association graph” for short. A vertex in the identifier association graph may correspond to a source identifier or a target identifier. An edge between two vertexes may correspond to an association relation between a source identifier and a target identifier, and the edge can be directional (e.g., shown by an arrow) that represents a temporal order between two vertexes. For example, an arrow pointing from the first vertex to the second vertex represents that the second vertex appears or occurs at a time after the first vertex. In addition, the identifier association graph may also be represented in the form of text (e.g., TXT, XML, or other typical text markup tool). Furthermore, those skilled in the art would readily appreciate that an association relation between identifiers can be represented in various proper forms, without limitation to the graph or text file that merely serves as an example here.

The identifier association graph can be accomplished in the background. According to the identifier association graph, the associated target identifier can be directly determined from the source identifier, thereby improving the real-time processing speed and increasing the processing efficiency.

In another embodiment of the present invention, when there are a relatively large number of source objects and/or target objects, association relations between source objects and target objects can be built in the form of a graph, which is referred to as an “object association graph” for short. Like an identifier association graph, a vertex in the object association graph may correspond to a source object or a target object. An edge between two vertexes may correspond to an association relation between a source object and a target object, and the edge can be directional (e.g., shown by an arrow) that represents a precedence sequence between the two vertexes. It should be noted that an association relation between objects can be represented in various proper forms, without limitation to the graph or text file that merely serves as an example here.

The object association graph can be accomplished in the background. According to the object association graph, the associated target object can be directly determined from the source object, thereby improving the real-time processing speed and increasing the processing efficiency.

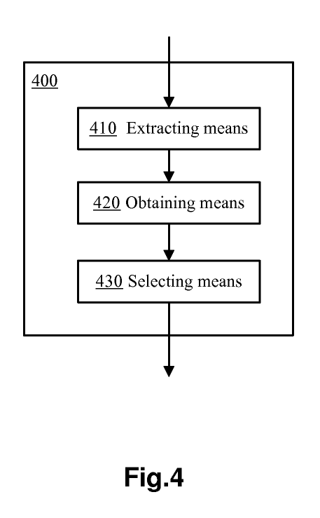

FIG. 4 is a block diagram of an apparatus 400 for identifier retrieval according to one embodiment of the present invention. The apparatus 400 for identifier retrieval may include: extracting means 410, obtaining means 420, and selecting means 430. The extracting means 410 can be configured to extract candidate identifiers from a data source according to a source identifier. The obtaining means 420 can be configured to obtain a profile of the source identifier and profiles of the candidate identifiers from the data source. The selecting means 430 can be configured to select a target identifier associated with the source identifier from the candidate identifiers according to the profile of the source identifier and the profiles of the candidate identifiers.

In one embodiment of the present invention, the extracting means 410 can include: named entity recognizing means configured to recognize named entities from the data source; and candidate identifier extracting means configured to extract, from the recognized named entities, identifiers belonging to the same entity category as the source identifier, as candidate identifiers.

In one embodiment of the present invention, the obtaining means 420 can include: source identifier profile searching means configured to search the data source for information related to the source identifier so as to be used as a profile of the source identifier; and candidate identifier profile searching means configured to search the data source for information related to the candidate identifiers so as to be used as profiles of the candidate identifiers.

In one implementation, the source identifier profile searching means can further include: source identifier descriptive information looking up means configured to look up descriptive information on the source identifier in the profile of the source identifier; and source identifier profile updating means configured to update the profile of the source identifier with the descriptive information on the source identifier.

In one implementation, the candidate identifier profile searching means can further include: candidate identifier descriptive information looking up means configured to look up descriptive information on the candidate identifiers in the profiles of the candidate identifiers; and candidate identifier profile updating means configured to update the profiles of the candidate identifiers with the descriptive information on the candidate identifiers.

In one embodiment of the present invention, the selecting means 430 can include: a calculating unit configured to calculate a similarity between the source identifier and one of the candidate identifiers; and a selecting unit configured to select the one of the candidate identifiers as a target identifier associated with the source identifier when the similarity is greater than a predetermined threshold.

In one implementation, the calculating unit can include: source keyword extracting means configured to extract a source keyword from the profile of the source identifier; candidate keyword extracting means configured to extract a candidate keyword from the profile of one of the candidate identifiers; and similarity calculating means configured to calculate the similarity between the source identifier and the one of the candidate identifiers according to the source keyword and the candidate keyword.

In one embodiment of the present invention, the selecting means 430 can include: temporal order determining means configured to determine a temporal order between the source identifier and each of the candidate identifiers based on the profile of the source identifier and the profiles of the candidate identifiers; and target identifier selecting means configured to select a target identifier associated with the source identifier from the candidate identifiers when the temporal order meets a predetermined requirement.

In one embodiment of the present invention, the apparatus 400 for identifier retrieval can further include: receiving means (not shown), which can be configured to receive a source object input by a user; and looking up means (not shown), which can be configured to look up in the data source an identifier corresponding to the source object to be used as the source identifier.

In one embodiment of the present invention, the apparatus 400 for identifier retrieval can further include: determining means (not shown), which can be configured to determine a source object corresponding to the source identifier and a target object corresponding to the target identifier; and associating means (not shown), which can be configured to associate the source object with the target object.

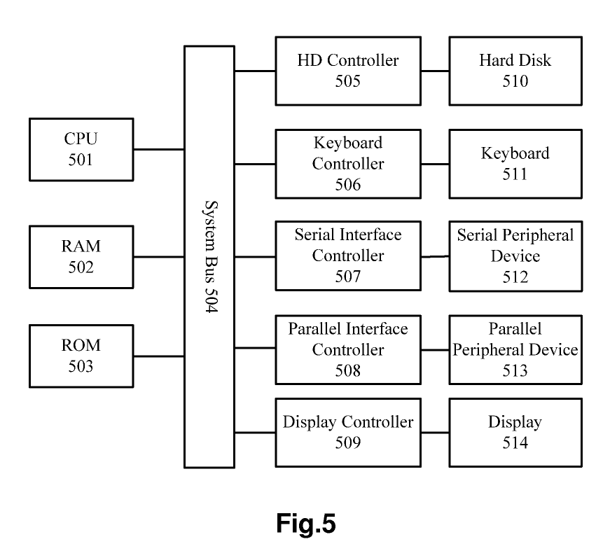

FIG. 5 schematically illustrates a structural block diagram of a computing apparatus in which embodiments according to the present invention can be implemented.

A computer system as illustrated in FIG. 5 includes a CPU (central processing unit) 501, RAM (random access memory) 502, ROM (read only memory) 503, a system bus 504, a hard disk controller 505, a keyboard controller 506, a serial interface controller 507, a parallel interface controller 508, a display controller 509, a hard disk 510, a keyboard 511, a serial peripheral device 512, a parallel peripheral device 513 and a display 514. Among these components, the CPU 501, the RAM 502, the ROM 503, the hard disk controller 505, the keyboard controller 506, the serial interface controller 507, the parallel interface controller 508, and the display controller 509 are connected to the system bus 504; the hard disk 510 is connected to the hard disk controller 505; the keyboard 511 is connected to the keyboard controller 506; the serial peripheral device 512 is connected to the serial interface controller 507; the parallel peripheral device 513 is connected to the parallel interface controller 508; and the display 514 is connected to the display controller 509.

The function of each component in FIG. 5 is publicly known in this technical field, and the structure as shown in FIG. 5 is conventional. In different applications, some components can be added to the structure shown in FIG. 5, or some components shown in FIG. 5 can be omitted. The whole system shown in FIG. 5 is controlled by computer readable instructions usually stored in the hard disk 510 as software, or stored in EPROM or other nonvolatile memories. The software can be downloaded from the network (not shown in the figure). The software stored in the hard disk 510 or downloaded from the network can be uploaded to RAM 502 and executed by the CPU 501 to perform functions determined by the software.

Although the computer system as described in FIG. 5 can support the identifier retrieval apparatus according to embodiments of the present invention, it is merely one example of a computer system. Those skilled in the art would readily appreciate that many other computer system designs can also realize embodiments of the present invention. The present invention further relates to a computer program product, which includes non-transient program code for: extracting candidate identifiers from a data source according to a source identifier; obtaining a profile of the source identifier and profiles of the candidate identifiers from the data source; and selecting a target identifier associated with the source identifier from the candidate identifiers according to the profile of the source identifier and the profiles of the candidate identifiers. Before use, the code can be stored in a memory of a computer system, for example, stored in a hard disk or a removable memory such as a CD or a floppy disk, or downloaded via the Internet or other computer networks.

The methods as disclosed in the present embodiments can be implemented in software, hardware or combination of software and hardware. The hardware portion can be implemented by using dedicated logic; the software portion can be stored in a memory and executed by an appropriate instruction executing system such as a microprocessor, a personal computer (PC) or a mainframe computer. In an embodiment, the present invention is implemented as software, including, without limitation to, firmware, resident software, micro-code, etc.

Moreover, the present invention can be implemented as a computer program product used by computers or accessible by computer-readable media that provide non-transient program code for use by or in connection with a computer or any instruction executing system. For the purpose of description, a computer-usable or computer-readable medium can be any tangible means that can contain, store, communicate, propagate, or transport the program for use by or in connection with an instruction execution system, apparatus, or device.

The medium can be an electric, magnetic, optical, electromagnetic, infrared, or semiconductor system (apparatus or device), or propagation medium. Examples of the computer-readable medium would include the following: a semiconductor or solid storage device, a magnetic tape, a portable computer diskette, a random access memory (RAM), a read-only memory (ROM), a hard disk, and an optical disk. Examples of the current optical disk include a compact disk read-only memory (CD-ROM), compact disk-read/write (CD-R/W), and DVD.

A system adapted for storing and/or executing program code according to embodiment of the present invention would include at least one processor that is coupled to a memory element directly or via a system bus. The memory element may include a local memory usable during actual execution of the non-transient program code, a mass memory, and a cache that provides temporary storage for at least one portion of non-transient program code so as to decrease the number of times for retrieving code from the mass memory during execution.

An Input/Output or I/O device (including, without limitation to, a keyboard, a display, a pointing device, etc.) can be coupled to the system directly or via an intermediate I/O controller.

A network adapter may also be coupled to the system such that the data processing system can be coupled to other data processing systems, remote printers or storage devices via an intermediate private or public network. A modem, a cable modem, and an Ethernet card are merely examples of a currently available network adapter.

The communication network mentioned in the specification may include various types of networks, including, without limitation, a local area network (“LAN”), a wide area network (“WAN”), a network according to IP Protocol (e.g., the Internet), and a peer-to-peer network (e.g., an ad hoc peer network).

It should be noted that some more specific technical details that are publicly known to those skilled in the art and that might be essential to the implementation of the present invention are omitted in the above description in order to make the present invention more easily understood.

The specification of the present invention has been presented for purposes of illustration and description, and is not intended to be exhaustive or limited to the invention in the form disclosed. Many modifications and variations will be apparent to those of ordinary skill in the art.

Therefore, the embodiments were chosen and described in order to best explain the principles of the invention and the practical application, and to enable others of ordinary skill in the art to understand that all modifications and alterations made without departing from the spirit of the present invention fall into the protection scope of the present invention as defined in the appended claims.

1-10. (canceled)

11. An apparatus for identifier retrieval, comprising:
extracting means configured to extract candidate identifiers from a data source according to a source identifier;
obtaining means configured to obtain a profile of said source identifier and profiles of said candidate identifiers from said data source; and
selecting means configured to select a target identifier associated with said source identifier from said candidate identifiers according to said profile of said source identifier and said profiles of said candidate identifiers.

12. The apparatus according to claim 11, wherein said extracting means comprises:
named entity recognizing means configured to recognize named entities from said data source; and
candidate identifier extracting means configured to extract as candidate identifiers, from said recognized named entities, identifiers belonging to the same entity category as said source identifier.

13. The apparatus according to claim 11, wherein said obtaining means comprises:
source identifier profile searching means configured to search said data source for information related to said source identifier so as to be used as a profile of said source identifier; and
candidate identifier profile searching means configured to search said data source for information related to said candidate identifiers so as to be used as profiles of said candidate identifiers.

14. The apparatus according to claim 13, wherein said source identifier profile searching means further comprises:
source identifier descriptive information looking up means configured to look up descriptive information on said source identifier in said profile of said source identifier; and
source identifier profile updating means configured to update said profile of said source identifier with said descriptive information on said source identifier.

15. The apparatus according to claim 13, wherein said candidate identifier profile searching means further comprises:
candidate identifier descriptive information looking up means configured to look up descriptive information on said candidate identifiers in said profiles of said candidate identifiers; and
candidate identifier profile updating means configured to update said profiles of said candidate identifiers with said descriptive information on said candidate identifiers.

16. The apparatus according to claim 11, wherein said selecting means comprises:
a calculating unit configured to calculate a similarity between said source identifier and one of said candidate identifiers; and
a selecting unit configured to select the one of said candidate identifiers as a target identifier associated with said source identifier provided that said similarity is greater than a predetermined threshold.

17. The apparatus according to claim 16, wherein said calculating unit comprises:
source keyword extracting means configured to extract a source keyword from said profile of said source identifier;
candidate keyword extracting means configured to extract a candidate keyword from said profile of one of said candidate identifiers; and
similarity calculating means configured to calculate said similarity between said source identifier and said one of said candidate identifiers according to said source keyword and said candidate keyword.

18. The apparatus according to claim 11, wherein said selecting means comprises:
temporal order determining means configured to determine a temporal order between said source identifier and said candidate identifiers based on said profile of said source identifier and said profiles of said candidate identifiers; and
target identifier selecting means configured to select a target identifier associated with said source identifier from said candidate identifiers when said temporal order meets a predetermined requirement.

19. The apparatus according to claim 11, further comprising:
receiving means configured to receive a source object input by a user; and
looking up means configured to look up in said data source an identifier corresponding to said source object to be used as said source identifier.

20. The apparatus according to claim 11, further comprising:
determining means configured to determine a source object corresponding to said source identifier and a target object corresponding to said target identifier; and
associating means configured to associate said source object with said target object
